(19) United States
(12) Patent Application Publication
(10) Pub. No.: US 2014/0061986 A1
(43) Pub. Date: Mar. 6, 2014

(54) SHOCK ABSORBER

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: WU-QI LI, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/973,158

(22) Filed: Aug. 22, 2013

(30) Foreign Application Priority Data
Aug. 28, 2012 (CN) 2012103095470

(51) Int. Cl. F16F 13/00

(52) U.S. Cl. CPC F16F 13/007
USPC 267/140.13

(57) ABSTRACT

A shock absorber includes a cylinder, a first buffering assembly, a second buffering assembly, and oil. The cylinder includes a separating portion protruding from an inner sidewall. The cylinder defines a first chamber and a second chamber positioned at opposite sides of the separating portion. The separating portion defines a through hole communicating between the first chamber and the second chamber. The first buffering assembly includes a piston rod received in the first chamber, and a first movable piston sleeved on the piston rod. The second buffering assembly includes a second movable piston received in the second chamber adjacent to the separating portion, a stabling piston received in the second chamber, and an elastic member received in the second chamber. The elastic member is positioned between the second movable piston and the stabling piston. Oil is filled between the first movable piston and the second movable piston.

### BACKGROUND

1. Technical Field

The present disclosure relates to shock absorbers, and particularly to a hydraulic shock absorber.

2. Description of Related Art

A hydraulic shock absorber may include a cylinder including an outer chamber and an inner chamber inside the outer chamber, a piston received in the inner chamber, a piston rod connected to the piston, and an elastic member positioned at a side of the piston and received in the inner chamber. The inner chamber communicates with the outer chamber via a plurality of filtering holes defined in a cylindrical sidewall of the cylinder. Oil is filled in the inner chamber and the outer chamber. When a shock is applied to the piston rod, the piston rod pushes the piston to move along a sidewall in the inner chamber. The piston resists the elastic member, and extrudes the oil in the inner chamber to the outer chamber via the filtering holes. When the shock disappears, the elastic member resists the piston. However, a structure of the shock absorber is complex, and a complicated manufacturing process is required to form the inner chamber and the outer chamber. Thus, a cost of the shock absorber is relatively high.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of an embodiment of a shock absorber.

FIG. 2 is a cross-sectional view of the shock absorber taken along a line II-II in FIG. 1.

FIG. 3 is a cross-sectional view of the shock absorber in FIG. 2 in a use state.

### DETAILED DESCRIPTION

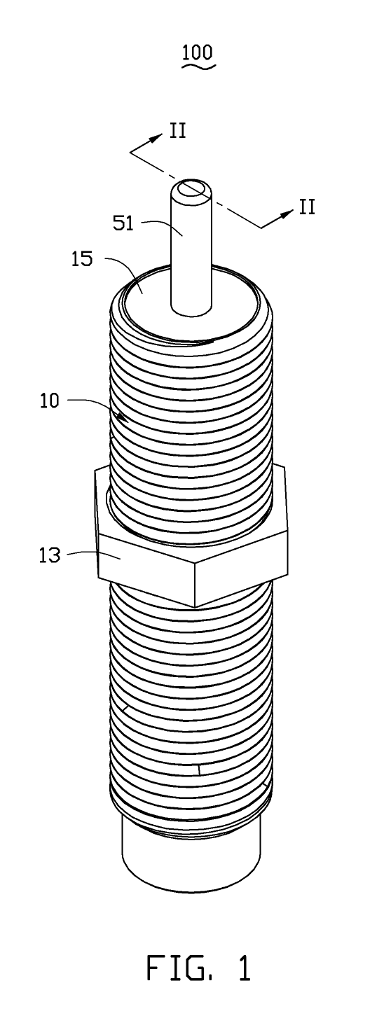

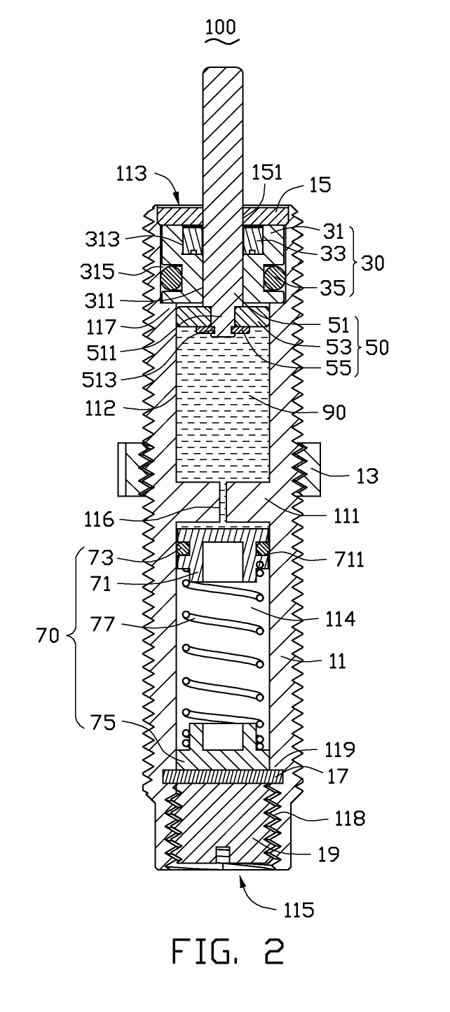

FIGS. 1 and 2 show one embodiment of a shock absorber 100. The shock absorber 100 includes a cylinder assembly 10, a guiding assembly 30, a first buffering assembly 50, a second buffering assembly 70, and damping oil 90. The guiding assembly 30, the first buffering assembly 50, and the second buffering assembly 70 are mounted in the cylinder assembly 10. The damping oil 90 is filled in the cylinder assembly 10 between the first buffering assembly 50 and the second buffering assembly 70.

The cylinder assembly 10 includes a cylinder 11, a fixing member 13, a first sealing member 15, a second sealing member 17, and a fastening member 19. The fixing member 13 is sleeved on the cylinder 11. The first sealing member 15 is mounted on an end of the cylinder 11, for sealing the end of the cylinder 11. The second sealing member 17 and the fastening member 19 are mounted on an opposite end of the cylinder 11, for sealing the opposite end of the cylinder 11.

The cylinder 11 is substantially a hollow cylinder, and includes a separating portion 111 at a substantially middle portion of an inner sidewall 1110 of the cylinder 11. The cylinder 11 includes a first chamber 112 and a second chamber 114, and defines a first opening 113 and a second opening 115. The first chamber 112 and the second chamber 114 are respectively positioned at opposite sides of the separating portion 111. The first opening 113 is defined at an end of the cylinder 11 adjacent to the first chamber 112, and communicates with the first chamber 112. The second opening 115 is defined at an opposite end of the cylinder 11 adjacent to the second chamber 114, and communicates with the second chamber 114. The separating portion 111 defines a through hole 116 communicating with the first chamber 112 and the second chamber 114. A diameter of the through hole 116 is smaller than a diameter of the second chamber 114. A blocking portion 117 protrudes from a portion of the inner sidewall 1110 adjacent to the first opening 113, for blocking and positioning the guiding assembly 30. A threaded portion 118 is formed on a portion of the inner sidewall 1110 adjacent to the second opening 115, for engaging with the fastening member 19. The inner sidewall 1110 defines a latching portion 119 at a side of the threaded portion 118 away from the second opening 115, for latching with the second sealing member 17. The fixing member 13 is sleeved on the cylinder 11, for assembling with a peripheral device (not shown), thus enabling the shock absorber 100 to be connected to the peripheral device.

The first sealing member 15 is mounted within the first opening 113, for sealing the first opening 113. The first sealing member 15 defines a through hole 151 along an axis of the cylinder 11. The second sealing member 17 is mounted within the latching portion 119, and is latched with the latching portion 119. The fastening member 19 is threaded into the threaded portion 118. The second sealing member 17 and the fastening member 19 cooperatively seal the second opening 115,. In the illustrated embodiment, the first sealing member 15 is a washer. The second sealing member 17 is a washer. The fastening member 19 is a nut.

The guiding assembly 30 includes a guiding sleeve 31, a third sealing member 33, and a fourth sealing member 35. The guiding sleeve 31 is substantially cylindrical, and is received in one end of the first chamber 112 adjacent to the first opening 113. The guiding sleeve 31 is positioned at a side of the first sealing member 15 adjacent to the separating portion 111, and is latched with the blocking portion 117. The guiding sleeve 31 defines an inserting hole 311 along the axis of the cylinder 11, and depresses an annular first receiving portion 313 at one end thereof adjacent to the first sealing member 15. An outer sidewall of the guiding sleeve 31 defines an annular second receiving portion 315. The third sealing member 33 is substantially a flexible ring, and is received in the first receiving portion 313. The fourth sealing member 35 is substantially a flexible ring, and is sleeved on the guiding sleeve 31 and received in the second receiving portion 315. In the illustrated embodiment, the guiding sleeve 31 is an axle sleeve. The third sealing member 33 is an oil seal. The fourth sealing member 35 is a seal ring.

The first sealing assembly 50 includes a piston rod 51, a first movable piston 53, and a latching member 55. The piston rod 51 is inserted into the through hole 151, the inserting hole 311 of the guiding sleeve 31, and the first chamber 112. The first sealing member 15, the third sealing member 33, and the guiding sleeve 31 are tightly sleeved on the piston rod 51. An end of the piston rod 51 extends out from the cylinder 11, an opposite end of the piston rod 51 is received in the first chamber 112. The piston rod 51 forms a mounting portion 511 at an end there of and is received in the first chamber 112. The mounting portion 511 defines a mounting groove 513 at an outer peripheral sidewall.

The first movable piston 53 is substantially a ring, and is sleeved on the mounting portion 511, and is positioned at a side of the mounting groove 513 away from the separating portion 111. The latching member 55 is substantially a ring, and is sleeved on the mounting portion 511, and is received in the mounting groove 513. The latching member 55 is fixed to the end of the 51 configured to prevent the first movable piston 53 dropping from the mounting portion 511.

The second buffering assembly 70 includes a second movable piston 71, a fifth sealing member 73, a stabling piston 75, and an elastic member 77. The second movable piston 71 is received in the second chamber 11 adjacent to the separating portion 111. The second movable piston 71 defines an annular receiving groove 711 at an outer sidewall. The fifth sealing member 73 is sleeved on the second movable piston 71, and is received in the receiving groove 711. The stabling piston 75 is received in the second chamber 114, and is located beside the second sealing member 17. The elastic member 77 is received in the second chamber 114, and is positioned between the second movable piston 71 and the stabling piston 75. An end of the elastic member 77 is sleeved on and resists against the second movable piston 71. An opposite end of the elastic member 77 is sleeved on and resists against the stabling piston 75.

The damping oil 90 is filled in a portion of the first chamber 112 and the second chamber 114 between the first movable piston 53 and the second movable piston 71.

In assembly, the fifth sealing member 73 is sleeved on the second movable piston 71. Opposite ends of the elastic member 77 are respectively sleeved on the second movable piston 71 and the stabling piston 75, and then the assembled second buffering assembly 70 is inserted into the second chamber 114 from the second opening 115. The second sealing member 17 is latched with the latching portion 119, and the fastening member 19 is threaded into the threaded portion 118, thus the second opening 11 is sealed. The oil 90 is filled into the first chamber 112 and the second chamber 114 from the first opening 113. The first movable piston 53 is sleeved on the piston rod 51, and then inserted into the first chamber 112 from the first opening 113 with the piston rod 51. The guiding assembly 30 assembled with the piston rod 51. The first sealing member 15 is sleeved on the piston rod 51, for sealing the first opening 113.

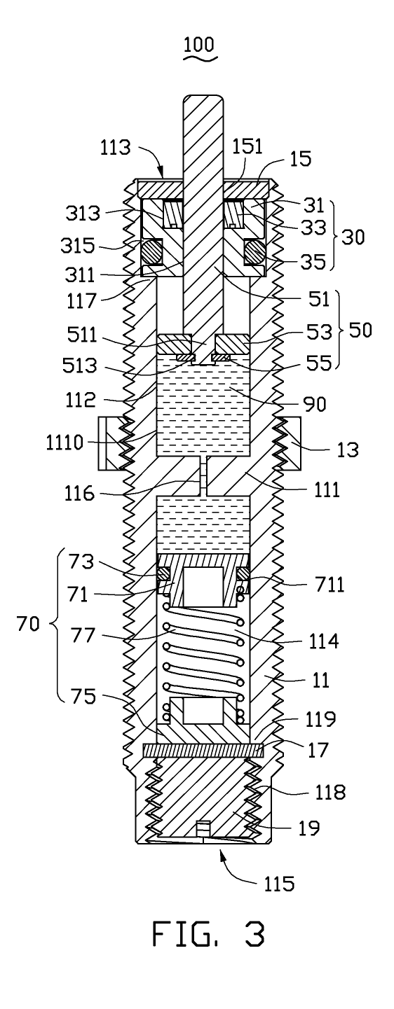

In operation, when a shock is applied to the piston rod 51 towards the first movable piston 53, the piston rod 51 pushes the first movable piston 53 to move along the inner sidewall 1110 towards the separating portion 111. The oil 90 in the first chamber 112 flows into the second chamber 114 via the through hole 116, and thus the oil 90 pushes the second movable piston 71 to move along the inner sidewall 1110 towards the stabling piston 75 by compressing the elastic member 77 (shown in FIG. 3). Thus, the shock is absorbed. When the shock on the piston rod 51 disappears, the compressed elastic member 77 returns to an original state, and pushes the second movable piston 71, and thus the second movable piston 71, the first movable piston 53, and the piston rod 51 also return to an original state (shown in FIG. 2).

In an alternative embodiment, the fixing member 13, the first sealing member 15, the second sealing member 17, and the fastening member 19 may be omitted, and the first movable piston 53 and the stabling piston 75 can respectively seal opposite ends of the cylinder 11. In an alternative embodiment, the guiding assembly 30 may be omitted, and movements of the piston rod 51 may be guided by the first movable piston 53. The latching member 55 may be omitted while the first movable piston 53 is tightly sleeved on the piston rod 51. The stabling piston 75 may be omitted, and then the elastic member 77 may resists on the cylinder 11 or the second sealing member 17.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A shock absorber, comprising:
a cylinder comprising a separating portion protruding from an inner sidewall of the cylinder, the cylinder defining a first chamber and a second chamber positioned at opposite sides of the separating portion, the separating portion defining a through hole communicating the first chamber and the second chamber;
a first buffering assembly, comprising:
a piston rod partly received in the first chamber and partly extending out from the cylinder; and
a first movable piston sleeved on the piston rod and received in the first chamber;
a second buffering assembly, comprising:
a second movable piston received in the second chamber; and
an elastic member received in the second chamber and positioned at a side of the second movable piston away from the first chamber, the elastic member resisting against the second movable piston;
damping oil received in the first chamber and the second chamber between the first movable piston and the second movable piston,
wherein when a shock is applied to the piston, the piston rod pushes the first movable piston to move along the inner sidewall of the cylinder towards the second movable piston, thus the second movable piston is pushed by the damping oil and moves along the inner sidewall of the cylinder by compressing the elastic member.

2. The shock absorber of claim 1, wherein the shock absorber further comprises a first sealing member, a second sealing member, and a fastening member, the cylinder further defines a first opening communicating with the first chamber and a second opening communicating with the second chamber, the first sealing member is mounted in the first opening for sealing the first opening, the second sealing member is mounted in the second opening for sealing the second opening, the fastening member is fixed with the second opening of the cylinder, the second sealing member and the fastening member cooperatively sealing the second opening.

3. The shock absorber of claim 1, wherein the first buffering assembly further comprises a latching member sleeved on an end of the piston rod adjacent to the first movable piston for preventing the first movable piston dropping from the piston rod.

4. The shock absorber of claim 3, wherein the piston rod comprises a mounting portion at the end of the piston rod adjacent to the first movable piston, the mounting portion defines a mounting groove, the first movable piston is mounted on the mounting portion and is positioned at a side of the mounting groove away from the separating portion, the latching member is sleeved on the mounting portion and is received in the mounting groove.

5. The shock absorber of claim 1 further comprising a guiding assembly, the guiding assembly comprising a guiding sleeve sleeved on the piston rod, a third sealing member sleeved on the piston rod, and a fourth sealing member sleeved on the guiding sleeve, the guiding sleeve defining a first receiving portion at a side away from the first movable piston and a second receiving portion at a periphery sidewall, the third sealing member received in the first receiving portion, the fourth sealing member received in the second receiving portion.

6. The shock absorber of claim 5, wherein the inner sidewall of the cylinder defines a blocking portion, the guiding sleeve is latched with the blocking portion.

7. The shock absorber of claim 1 further comprising a fixing member, wherein the fixing member is sleeved on the cylinder.

8. The shock absorber of claim 1, wherein the second buffering assembly further comprises a stabling piston received in the second chamber, the stabling piston is positioned at a side of the elastic member away from the first movable piston.

9. The shock absorber of claim 8, wherein the elastic member resists against the stabling piston.

10. The shock absorber of claim 8, wherein the second buffering assembly further comprising a fifth sealing member sleeved on the second movable piston.

11. A shock absorber, comprising:
a cylinder comprising a separating portion protruding from an inner sidewall of the cylinder, the cylinder defining a first chamber and a second chamber positioned at opposite sides of the separating portion, the separating portion defining a through hole communicating the first chamber and the second chamber, a diameter of the through hole smaller than a diameter of the second chamber;
a first buffering assembly, comprising:
a piston rod received in the first chamber; and
a first movable piston sleeved on the piston rod and received in the first chamber;
a second buffering assembly, comprising:
a second movable piston received in the second chamber adjacent to the separating portion, damping oil received in the first chamber and the second chamber between the first movable piston and the second movable piston;
a stabling piston received in the second chamber at a side of the second movable piston; and
an elastic member received in the second chamber and positioned between the second movable piston and the stabling piston, opposite ends of the elastic member resisting against the second movable piston and the stabling piston, respectively.

12. The shock absorber of claim 11, wherein the shock absorber further comprises a first sealing member, a second sealing member, and a fastening member, the cylinder further defines a first opening communicating with the first chamber and a second opening communicating with the second chamber, the first sealing member is mounted in the first opening for sealing the first opening, the second sealing member is mounted in the second opening for sealing the second opening, the fastening member fixed with the second opening of the cylinder, the second sealing member and the fastening member cooperatively sealing the second opening.

13. The shock absorber of claim 11, wherein the first buffering assembly further comprises a latching member sleeved on an end of the piston rod adjacent to the first movable piston, for preventing the first movable piston dropping from the piston rod.

14. The shock absorber of claim 13, wherein the piston rod comprises a mounting portion at the end of the piston rod adjacent to the first movable piston, the mounting portion defines a mounting groove, the first movable piston is mounted on the mounting portion and is positioned at a side of the mounting groove away from the separating portion, the latching member is sleeved on the mounting portion and is received in the mounting groove.

15. The shock absorber of claim 11 further comprising a guiding assembly, the guiding assembly comprising a guiding sleeve sleeved on the piston rod, a third sealing member sleeved on the piston rod, and a fourth sealing member sleeved on the guiding sleeve, the guiding sleeve defining a first receiving portion at a side away from the first movable piston and a second receiving portion at a periphery sidewall, the third sealing member is received in the first receiving portion, the fourth sealing member is received in the second receiving portion.

16. The shock absorber of claim 15, wherein the inner sidewall of the cylinder defines a blocking portion, the guiding sleeve is latched with the blocking portion.

17. The shock absorber of claim 11 further comprising a fixing member, wherein the fixing member is sleeved on the cylinder.

18. The shock absorber of claim 11, wherein opposite ends of the elastic member are respectively sleeved on the second movable piston and the stabling piston.

19. The shock absorber of claim 11, wherein the second buffering assembly further comprising a fifth sealing member sleeved on the second movable piston.
